(19) United States
(12) Patent Application Publication
(10) Pub. No.: US 2014/0198835 A1
(43) Pub. Date: Jul. 17, 2014

(54) METHOD AND SYSTEM FOR A MULTI-STANDARD RECEIVER

(71) Applicant: Maxlinear, Inc., Carlsbad, CA (US)

(72) Inventors: Curtis Ling, Carlsbad, CA (US); Rajasekhar Pullela, Irvine, CA (US)

(21) Appl. No.: 14/155,120

(22) Filed: Jan. 14, 2014

Related U.S. Application Data
(60) Provisional application No. 61/753,211, filed on Jan. 16, 2013.

(51) Int. Cl. H04L 27/01; H04L 27/06

(52) U.S. Cl. CPC H04L 27/01; H04L 27/06
USPC 375/230

(57) ABSTRACT

A multi-standard receiver may comprise in an electronic device, receiving an input radio frequency (RF) signal comprising at least two RF signals of different communication standards. The input RF signal may be separated into two signals based on their different communication standard sand configurable gain levels may be applied to equalize their magnitudes. The amplified signals may be combined, and the combined signals may be converted to a digital signal. The configurable gain may be applied to the two signals using variable gain amplifiers. A null may be generated at the input of at least one of the variable gain amplifiers utilizing a mixer and a filter, both configured to a desired frequency. The desired frequency may correspond to an interferer signal. The input RF signal may be separated into two signals utilizing a diplexer. The input RF signal may be received from a wired connection and/or an antenna.

### CLAIM OF PRIORITY

This patent application makes reference to, claims priority to and claims benefit from U.S. Provisional Application Ser. No. 61/753,211 filed on Jan. 16, 2013.

The above stated application is hereby incorporated herein by reference in its entirety.

### INCORPORATION BY REFERENCE

This application also makes reference to:

U.S. patent application Ser. No. 13/485,003 filed on May 31, 2012; and
U.S. patent application Ser. No. 13/336,451 filed on Dec. 23, 2011.

Each of the above stated applications is hereby incorporated herein by reference in its entirety.

### FIELD

Certain embodiments of the invention relate to communications. More specifically, certain embodiments of the invention relate to a method and a system for multi-layer time-interleaved analog-to-digital convertor (ADC).

### BACKGROUND

Communications typically include transmitting or receiving analog signals over wireless and/or wired connections. The analog signals may be used to carry data (e.g., content), which may be embedded into the analog signals using analog or digital modulation schemes. In this regard, for analog communications, data is transferred using continuously varying analog signals, and for digital communications, the analog signals are used to transfer discrete messages in accordance with a particular digitalization scheme. Therefore, digital communications information requires performing, among other things, digital-to-analog conversion at the transmitting end and analog-to-digital conversion at the receiving end. Such conversions may be complex, may be time consuming, may require considerable power, and/or may introduce errors or distortion.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY

A system and/or method is provided for a multi-standard receiver, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary electronic device, in accordance with an example embodiment of the disclosure.

FIG. 2 is a block diagram illustrating a multi-standard receiver, in accordance with an example embodiment of the disclosure.

FIG. 3A is a block diagram illustrating null generation for a multi-standard receiver, in accordance with an example embodiment of the disclosure.

FIG. 3B is a block diagram illustrating null generation for a multi-standard receiver utilizing a passive mixer feedback path, in accordance with an example embodiment of the disclosure.

FIG. 4 is a flow diagram illustrating example steps for a multi-standard receiver, in accordance with an example embodiment of the disclosure.

FIG. 5 is a flow diagram illustrating example steps for null generation in a multi-standard receiver, in accordance with an example embodiment of the disclosure.

### DETAILED DESCRIPTION OF THE INVENTION

Certain embodiments of the disclosure may be found in a method and system for a multi-standard receiver. In various embodiments, in an electronic device, an input radio frequency (RF) signal may be received comprising at least two RF signals of different communication standards. The input RF signal may be separated into two signals based on their different communication standards and configurable gain levels may be applied to amplify the two signals to equalize their magnitudes. The amplified signals may be combined, and the combined signals may be converted to a digital signal. The configurable gain may be applied to the two signals using variable gain amplifiers. A null may be generated at the input of at least one of the variable gain amplifiers utilizing a mixer and a filter, both configured to a desired frequency. The desired frequency may correspond to an interferer signal. The input RF signal may be separated into two signals utilizing a diplexer. The input RF signal may be received from a wired connection and/or an antenna.

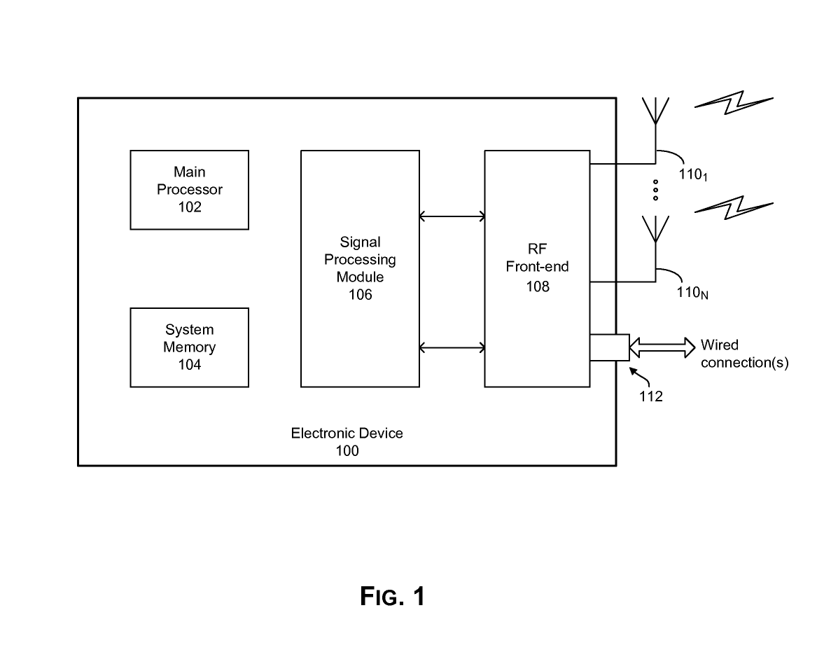

FIG. 1 is a block diagram illustrating an exemplary electronic device, in accordance with an example embodiment of the disclosure. Referring to FIG. 1 there is shown an electronic device 100.

The electronic device 100 may comprise suitable logic, circuitry, interfaces, and/or code that may be operable to implement various aspects of the invention. In this regard, the electronic device may support communication over wired and/or wireless connections. For example, the electronic device 100 may support a plurality of wired and/or wireless interfaces and/or protocols, and may be operable to perform necessary processing operations to facilitate transmission and/or reception of signals (e.g. RF signals) over supported wired and/or wireless interfaces. Exemplary electronic devices may comprise cellular/smart phones or similar handheld devices, tablets, desktop computers, laptops computers, servers, personal media players, set top boxes or broadband receivers, and/or other like devices. Exemplary wireless protocols or standards that may be supported and/or used by the electronic device 100 may comprise wireless personal area network (WPAN) protocols, such as Bluetooth (IEEE 802.15); wireless local area network (WLAN) protocols, such as WiFi (IEEE 802.11); cellular standards, such as 2G/2G+ (e.g., GSM/GPRS/EDGE) and 3G/3G+ (e.g., CDMA2000, UMTS, HSPA); 4G standards, such as WiMAX (IEEE 802.16) and LTE; Ultra-Wideband (UWB); and/or wireless TV/broadband (access) standards, such as terrestrial and/or satellite TV standards (e.g., DVB-T/T2, DVB-S/S2). Exemplary wired protocols and/or interfaces that may be supported and/or used by the electronic device 100 may comprise Ethernet (IEEE 802.3), Fiber Distributed Data Interface (FDDI), Integrated Services Digital Network (ISDN); and/or wired based TV/broadband (access) standards, such as Digital Subscriber Line (DSL), Data Over Cable Service Interface Specification (DOCSIS), Multimedia over Coax Alliance (MoCA).

The electronic device 100 may comprise, for example, a main processor 102, a system memory 104, a signal processing module 106, a radio frequency (RF) front-end 108, a plurality of antennas 110₁-110_{N}, and one or more wired connectors 112. The main processor 102 may comprise suitable logic, circuitry, interfaces, and/or code that may be operable to process data, and/or control and/or manage operations of the electronic device 100, and/or tasks and/or applications performed therein. In this regard, the main processor 102 may be operable to configure and/or control operations of various components and/or subsystems of the electronic device 100, by utilizing, for example, one or more control signals. The main processor 102 may enable execution of applications, programs and/or code, which may be stored in the system memory 104, for example. The system memory 104 may comprise suitable logic, circuitry, interfaces, and/or code that may enable permanent and/or non-permanent storage, buffering, and/or fetching of data, code and/or other information, which may be used, consumed, and/or processed in the electronic device 100. In this regard, the system memory 104 may comprise different memory technologies, including, for example, read-only memory (ROM), random access memory (RAM), Flash memory, solid-state drive (SSD), and/or field-programmable gate array (FPGA). The system memory 104 may store, for example, configuration data, which may comprise parameters and/or code, comprising software and/or firmware.

The signal processing module 106 may comprise suitable logic, circuitry, interfaces, and/or code for enabling processing of signals transmitted and/or received by the electronic device 100. The signal processing module 106 may be operable to perform such signal processing operation as filtering, amplification, up-convert/down-convert baseband signals, analog-to-digital and/or digital-to-analog conversion, encoding/decoding, encryption/decryption, and/or modulation/demodulation.

The RF front-end 108 may comprise suitable logic, circuitry, interfaces, and/or code that may be operable to perform RF transmission and/or reception during wireless and/or wired communications, such over a plurality of supported RF bands and/or carriers. The RF front-end subsystem 108 may be operable to perform, for example, wireless communications of RF signals via the plurality of antennas 110₁-110_{N}. Each of the plurality of antennas 110₁-110_{N} may comprise suitable logic, circuitry, interfaces, and/or code that may enable transmission and/or reception of RF signals within certain bandwidths and/or based on certain protocols. The RF front-end subsystem 108 may be operable to perform wired communications of RF signals via the plurality of connectors 112. The wired connectors 112 may comprise suitable logic, circuitry, interfaces, and/or code that may enable transmission and/or reception of RF signals over wired connections, within certain bandwidths and/or based on certain protocols (e.g., MoCA).

In addition, the RF front-end 108 may comprise one or more diplexers that may be operable to receive signals of at least two standards and/or frequencies and separate the different standard/frequency signals to two separate outputs. For example, the RF front-end 108 may receive both DOCSIS and MoCA signals from a wired connection and a diplexer may split the DOCSIS and MoCA signals into two separate signals at different outputs of the diplexer. The diplexer may, for example, operate on the basis of frequency division multiplexing where the first standard is in a first frequency band and the second standard is in a second frequency band.

In an example scenario, the main processor 102, the system memory 104, the signal processing module 106, and the RF front-end 108 may be integrated on a single chip, or integrated circuit. Diplexers in the RF front-end 108 may be integrated on-chip or may be off-chip.

In operation, the electronic device 100 may be operable to perform wired and/or wireless communication, in accordance with one or more interfaces and/or protocols supported thereby. In this regard, the electronic device 100 may be operable to transmit and/or receive RF signals over supported wired and/or wireless interfaces, using the RF front-end 108, and to perform necessary signal processing operations to facilitate such transmission/reception, using the signal processing module 106. The RF signals transmitted and/or received by the electronic device 100 may carry data pertaining to applications running in the electronic device 100. The RF signals communicated to/from the electronic device 100 may comprise analog signals, in which the communicated data may be embedded using analog or digital modulation schemes. In this regard, during analog communications, data may be transferred using continuously varying analog signals, and during digital communications, the analog signals are used to transfer discrete messages in accordance with particular digitalization scheme. Accordingly, during performance of digital communications, the signal processing operations performed by the electronic device 100 may comprise, among other things, digital-to-analog conversion on the transmitting side and analog-to-digital conversion on the receiving side. Such conversions may be complex, may be time consuming, may require considerable power, and/or may introduce errors or distortions, especially when very wideband signals are communicated.

In an example scenario, signals conforming to a plurality of standards may be processed by the receiver 100 and may be received from a single wired connection or antenna. Because the magnitude of the signals of the different standard signals may vary significantly, diplexers may be utilized to separate signals of different standards and each output of the diplexer may be passed to a variable gain amplifier, a gain of which may be based on measured signal strength of the signals at the first output of the diplexer, measured signal strength of the signals at the second output of the diplexer, empirical knowledge about the two standards and/or the location/installation of the receiver, and/or any other suitable parameter(s). The gain of the two amplifiers may be set such that the signal strength at the outputs of the two amplifiers are roughly equal (e.g., such that the dynamic range requirements of the ADC are below a threshold).

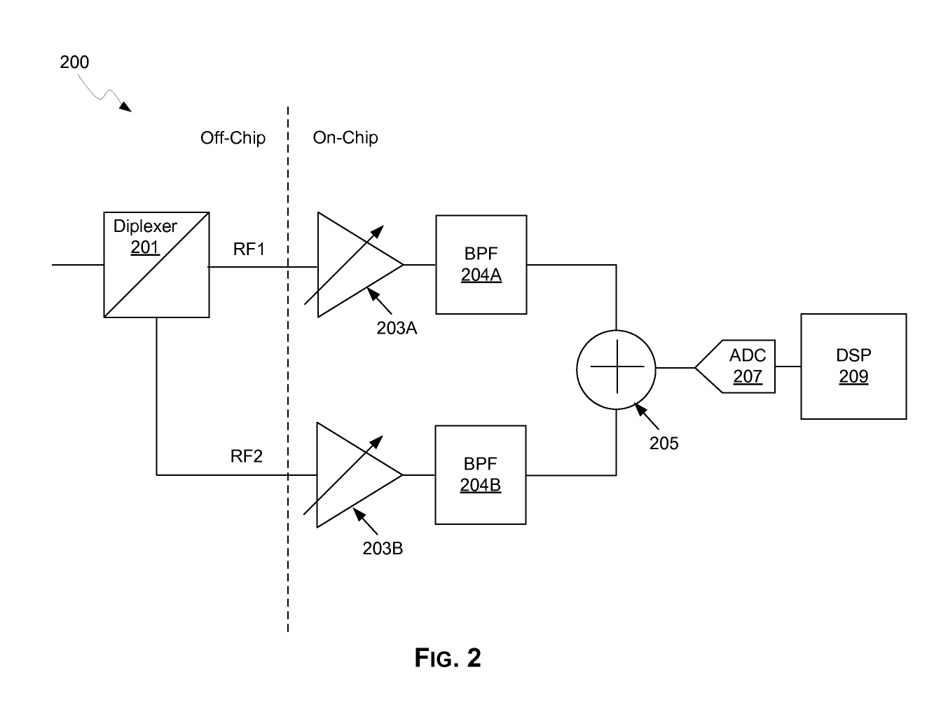

FIG. 2 is a block diagram illustrating a multi-standard receiver, in accordance with an example embodiment of the disclosure. Referring to FIG. 2, there is shown an RF receiver 200 comprising a diplexer 201, variable gain amplifiers (VGAs) 203A and 203B, bandpass filters 204A and 204B, a combiner 205, an analog-to-digital converter (ADC) 207, and a digital signal processor (DSP). The VGAs 203A and 303B may comprise configurable amplifiers that may amplify received signals with the gain controlled by a processor, such as the main processor 102, for example.

The diplexer 201 is shown off-chip, but may be on-chip, and may be operable to pass signals of a first standard (e.g., CaTV/DOCSIS) to a first output and pass signals of a second standard to a second output (e.g., MoCA). The diplexer 201 may, for example, operate on the basis of frequency division multiplexing where the first standard is in a first frequency band and the second standard is in a second frequency band. Each output of the diplexer may be passed to the VGA 203A or 203B, a gain of which may be based on measured signal strength of the signals at the first output of the diplexer, measured signal strength of the signals at the second output of the diplexer, empirical knowledge about the two standards and/or the location/installation of the receiver, and/or any other suitable parameter(s). While only a diplexer is shown in FIG. 2, it should be noted that the disclosure is not limited to the two paths shown as an example. Accordingly, any number of paths and filters/demultiplexers may be utilized, depending on the desired number of signals, for example.

The gain of the VGAs 203A and 203B may be set such that the signal strength at the outputs of the two amplifiers are roughly equal (e.g., such that the dynamic range requirements of the ADC are below a threshold). Accordingly, the gain applied to each signal may be greater for the weaker received signal and weaker for the stronger received signal. The outputs of the two amps may be filtered by the bandpass filters 204A and 204B, which may pass the desired signal while attenuating out-of-band noise and distortion from the VGAs 203A and 203B. The outputs of the filters 203A and 203B may be combined by the combiner 205, which may be operable to generate a single output signal that is the sum of the input signals.

The summed signal may then be digitized by the ADC 209 (which may be, for example, a full-spectrum capture ADC such as, for example, an ADC described in U.S. patent application Ser. No. 13/485,003 and/or U.S. patent application Ser. No. 13/336,451, each of which is incorporated by reference in its entirety.

The RF receiver 200 may comprise suitable logic, circuitry, code, and/or interfaces operable to perform RF reception and/or processing operations related thereto. In this regard, the RF receiver 200 may incorporate a single-chip receiver architecture, in which the entire receiving path may be integrated onto a single chip, other than the diplexer 201 in an example embodiment, which may directly provide various RF reception related function(s) comprising, e.g., receiving RF (analog) signals (e.g., via antennas or wired-based connectors), amplification, sampling and analog-to-digital conversions (if needed), and at least some of the required signal processing (e.g., baseband/passband processing and/or digital signal processing).

The RF receiver 200 may provide analog-to-digital conversion (ADC). In this regard, when the received (analog) signals comprise digitally modulated communication, the RF receiver 200 may be operable to perform analog-to-digital conversions, to enable the generation of digital signals based on sampling of the analog signals, in which a sequence of samples—that is sequence of discrete-time information—may be determined and/or generated based on the received analog signals. The signal sampling may be achieved by reading the value of continuous input analog signals at certain, periodic intervals as determined by an applicable sampling rate for example.

The RF receiver 200 may also incorporate at least a portion of a digital signal processing (DSP) 209, to support the single-chip receiver architecture. In this regard, the DSP block 209 may perform computationally intensive processing of data during communication operations. The DSP block 209 may be operable to, for example, encode, decode, modulate, demodulate, encrypt, decrypt, scramble, descramble, and/or otherwise process data that may be carried in transmitted or received signals. The DSP block 209 may be configured to select, apply, and/or adjust a modulation scheme, error coding scheme, and/or data rates based on type and/or characteristics of interface being used in communicating the signals (carrying the data).

By splitting signals of different communications standards, such as CaTV/DOCSIS and MoCA, at the diplexer 201, where input signal strengths may vary widely, the dynamic range requirements of the ADC 207 may be greatly reduced. Since the split signals may amplified by the VGAs 203A and 203B at configurable gain levels to make the resulting signals approximately equal, the ADC 207 does not need to have the dynamic range to digitize a very low magnitude signal as well as a high magnitude signal. In this manner, a single full-spectrum capture ADC may be utilized instead of multiple ADCs for different communications standards.

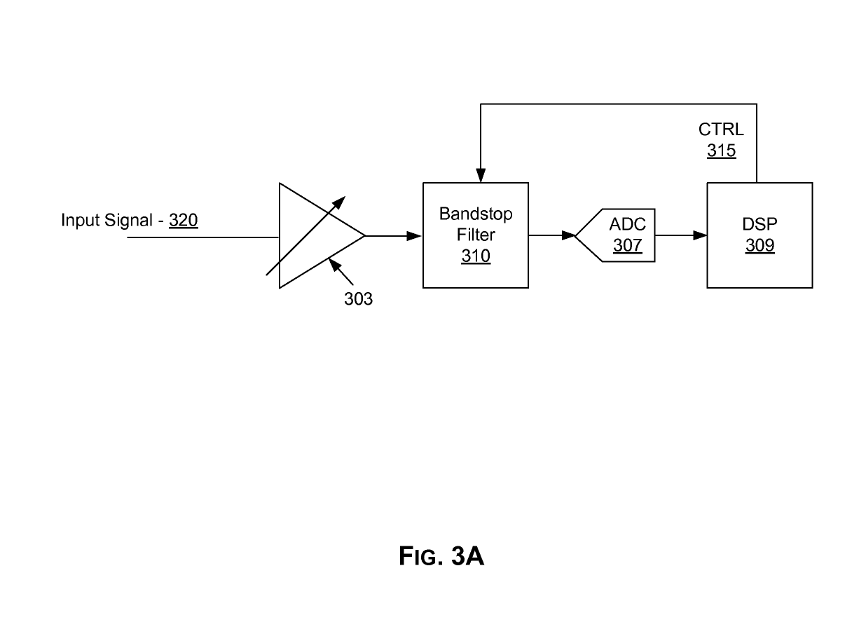

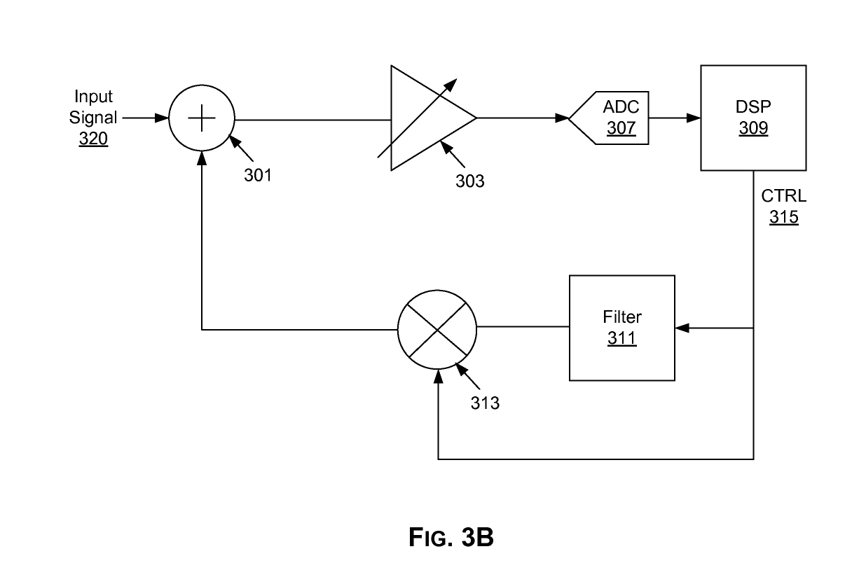

FIG. 3A is a block diagram illustrating null generation for a multi-standard receiver, in accordance with an example embodiment of the disclosure. Referring to FIG. 3A, there is shown a VGA 303, an ADC 307, a DSP 309, and a bandstop filter 310. The VGA 303, ADC 307, and DSP 309 may be substantially similar to the VGAs 203A/203B, ADC 207, and DSP 209 described with respect to FIG. 2. There is also shown an input signal 320 and a control signal 315.

The bandstop filter 311 may comprise a filter that may be configured to filter out signals within a particular frequency range while allowing other frequency ranges to pass. The bandstop filter 311 may be configurable, in that the stop frequency and/or bandwidth may be configured by the control signal 315.

The input signal 301 may be coupled to the VGA 303 with a full-band received, in that both desired and undesired signals may be captured. While the bandstop filter 310 may filter out some of an unwanted signal at first pass, some undesired signal may still reach the ADC 307 and subsequently the DSP 309. The undesired frequency and bandwidth may, for example, correspond to a known interferer. For example, for receipt of CATV/DOCSIS, the input signal 320 may comprise DOCSIS and MoCA signals, which get amplified by the VGA 303, by the bandstop filter 310 may largely attenuate the MoCA signal, but still allow some through. The DSP 309 may tune the response of the bandstop filter 310 dynamically to minimize and/or eliminate the unwanted signal even if it changes.

FIG. 3B is a block diagram illustrating null generation for a multi-standard receiver utilizing a passive mixer feedback path, in accordance with an example embodiment of the disclosure. Referring to FIG. 3B, there is shown the VGA 303, the ADC 307, the DSP 309, a filter 311, and a mixer 313. The VGA 303, ADC 307, and DSP 309 may be substantially similar to the VGAs 203A/203B, ADC 207, and DSP 209 described with respect to FIG. 2. There is also shown an input signal 320 and a control signal 315.

The filter 311 may comprise a filter that may be configured to filter out signals within a particular frequency range while allowing other frequency ranges. Accordingly, the filter 311 may comprise a low-pass, high-pass, bandpass, or notch filter, for example.

The mixer 313 may comprise suitable circuitry for generating an output signal at a frequency that is a sum or difference frequency of the input signal 301 and a second input signal frequency from the DSP 309, which may be part of the control signal 315. In an example scenario, the mixer 313 comprises a passive mixer in that it is not necessary for a baseband signal from the DSP 309 be communicated to the mixer 313 to generate a null at the input of the VGA 303.

The input signal 301 may be coupled to the VGA 303 and the mixer 303, with an output of the mixer 313 coupled to the filter 311. The LO frequency of the mixer 313 and the frequency response of the filter 311 may be controlled (e.g., by one or more control signals 315 from the DSP 309) such that a null of desired frequency and bandwidth appears at the input of the VGA 303. The desired frequency and bandwidth may, for example, correspond to a known interferer. For example, for receipt of CATV/DOCSIS the mixer 313 and filter 311 may be configured such that a null which attenuates MoCA signals is present at the input of the VGA 303.

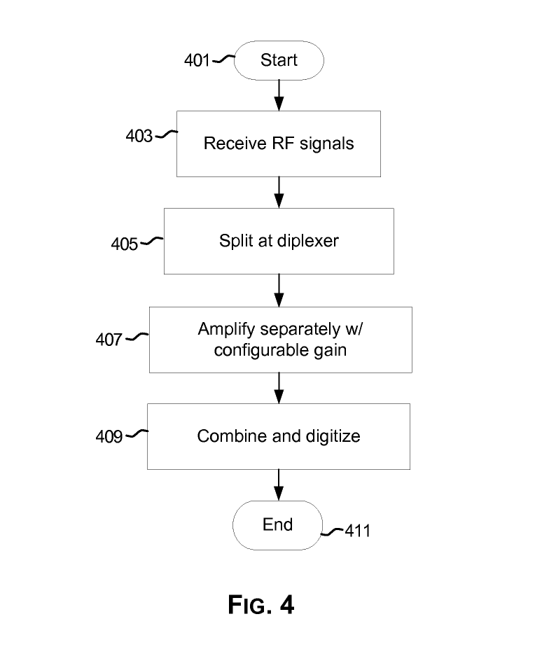

FIG. 4 is a flow diagram illustrating example steps for a multi-standard receiver, in accordance with an example embodiment of the disclosure. The exemplary method illustrated in FIG. 4 may, for example, share any or all functional aspects discussed previously with regard to FIGS. 1-3.

Referring to FIG. 4, after start step 401, in step 403, RF input signals may be received by the RF front end 108 of the electronic device 100. The RF input signals may be communicated from a cable television or satellite television service provider, from terrestrial television signals, and/or from a network device within the premises in which the electronic device 100 is located.

In step 405, the signals may be split at a diplexer based on the communication standard under which they are communicated, e.g., CaTV and MoCA.

In step 407, the gain may be applied separately to the split signals with the gain level configured to make the resulting signals approximately equal in magnitude.

In step 409, the amplified signals may be combined before being digitized by an ADC. By splitting the signals, amplifying them separately to equalize their magnitudes before summing and digitizing, the dynamic range requirements for the ADC may be greatly relaxed. This is followed by end step 411.

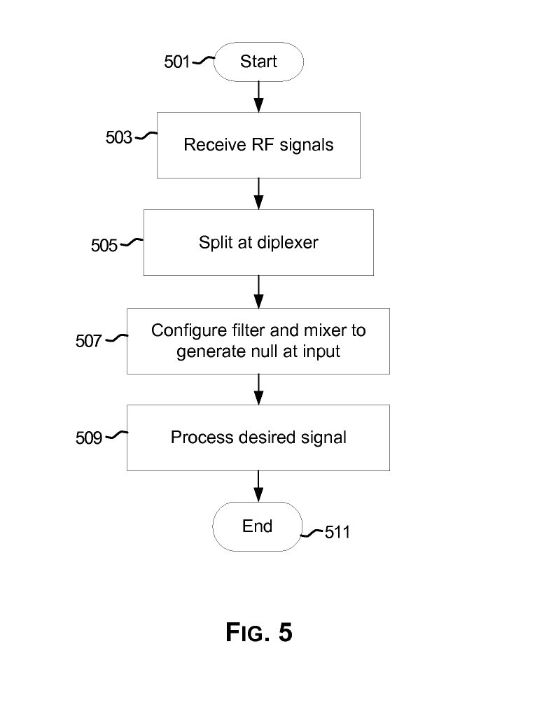

FIG. 5 is a flow diagram illustrating example steps for null generation in a multi-standard receiver, in accordance with an example embodiment of the disclosure. The exemplary method illustrated in FIG. 5 may, for example, share any or all functional aspects discussed previously with regard to FIGS. 1-4.

Referring to FIG. 5, after start step 501, in step 503, RF input signals may be received by the RF front end 108 of the electronic device 100. The RF input signals may be communicated from a cable television or satellite television service provider, from terrestrial television signals, and/or from a network device within the premises in which the electronic device 100 is located.

In step 505, the signals may be split at a diplexer based on the communication standard under which they are communicated, e.g., CaTV and MoCA.

In step 507, a mixer and filter may be tuned at a desired frequency, e.g., an interferer frequency such that a null is generated at the input to the gain stage following the diplexer.

In step 509, the desired signal may be processed with the interferer nulled out by the configured mixer and filter. This is followed by end step 511.

Various embodiments of the disclosure may comprise a method and system for a multi-standard receiver. Aspects of the disclosure may comprise in an electronic device, receiving an input radio frequency (RF) signal comprising at least two RF signals of different communication standards. The input RF signal may be separated into two signals based on their different communication standards and configurable gain levels may be applied to amplify the two signals to equalize their magnitudes.

The amplified signals may be combined, and the combined signals may be converted to a digital signal. The configurable gain may be applied to the two signals using variable gain amplifiers. A null may be generated at the input of at least one of the variable gain amplifiers utilizing a mixer and a filter, both configured to a desired frequency. The desired frequency may correspond to an interferer signal. The input RF signal may be separated into two signals utilizing a diplexer. The input RF signal may be received from a wired connection and/or an antenna.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in an electronic device:
receiving an input radio frequency (RF) signal comprising at least two RF signals of different communication standards;
separating the input RF signal into at least two signals based on their different communication standards;
amplifying the two signals by applying configurable gain levels to equalize their magnitudes;
combining the amplified signals; and
converting the combined signals to a digital signal.

2. The method according to claim 1, comprising applying the configurable gain levels to the at least two signals using variable gain amplifiers.

3. The method according to claim 2, comprising generating a null at the input of at least one of the variable gain amplifiers utilizing a mixer and a filter, both configured to a desired frequency.

4. The method according to claim 3, wherein the desired frequency corresponds to an interferer signal.

5. The method according to claim 1, comprising separating the input RF signal into two signals utilizing a diplexer.

6. The method according to claim 1, comprising receiving said input RF signal from a wired connection.

7. The method according to claim 1, comprising receiving said input RF signal from an antenna.

8. A system, comprising:
one or more circuits for use in an electronic device, the one or more circuits being operable to:
receive an input radio frequency (RF) signal comprising at least two RF signals of different communication standards;
separate the input RF signal into at least two signals based on their different communication standards;
amplify the at least two signals by applying configurable gain levels to equalize their magnitudes;
combine the amplified signals; and
convert the combined signals to a digital signal.

9. The system according to claim 8, wherein said one or more circuits are operable to apply the configurable gain levels to the at least two signals using variable gain amplifiers.

10. The system according to claim 9, wherein said one or more circuits are operable to generate a null at the input of at least one of the variable gain amplifiers utilizing a mixer and a filter, both configured to a desired frequency.

11. The system according to claim 10, wherein the desired frequency corresponds to an interferer signal.

12. The system according to claim 8, wherein said one or more circuits are operable to separating the input RF signal into two signals utilizing a diplexer.

13. The system according to claim 8, wherein said one or more circuits are operable to receive said input RF signal from a wired connection.

14. The system according to claim 8, wherein said one or more circuits are operable to receive said input RF signal from an antenna.

15. A system, comprising:
a radio frequency (RF) receiver implemented on a single chip, the RF receiver comprising:
at least two variable gain stages with inputs that are coupled to outputs of a diplexer;
a combiner coupled to outputs of the at least two variable gain stages; and
an analog-to-digital converter (ADC) coupled to an output of the combiner.

16. The system according to claim 15, wherein said diplexer is off-chip.

17. The system according to claim 15, wherein said diplexer is integrated on said chip.

18. The system according to claim 15, wherein said RF receiver is operable to amplify two signals received from the diplexer to equalize their magnitudes.

19. The system according to claim 18, wherein said RF receiver is operable to combine the amplified signals.

20. The system according to claim 15, wherein said RF receiver is operable to digitize the combined signals.
